(19) United States
(12) Patent Application Publication
(10) Pub. No.: US 2014/0241007 A1
(43) Pub. Date: Aug. 28, 2014

(54) REFLECTOR, LIGHT SOURCE MODULE, AND DISPLAY DEVICE

(71) Applicants: Chia-Hua Chen, Hsin-Chu (TW); Jhong-Hao Wu, Hsin-Chu (TW); Chin-Ku Liu, Hsin-Chu (TW); Cheng-Hsi Hsieh, Hsin-Chu (TW)

(72) Inventors: Chia-Hua Chen, Hsin-Chu (TW); Jhong-Hao Wu, Hsin-Chu (TW); Chin-Ku Liu, Hsin-Chu (TW); Cheng-Hsi Hsieh, Hsin-Chu (TW)

(73) Assignee: YOUNG LIGHTING TECHNOLOGY INC., Hsin-Chu (TW)

(21) Appl. No.: 14/185,881

(22) Filed: Feb. 20, 2014

(30) Foreign Application Priority Data
Feb. 22, 2013 (CN) 201310056579.9

(51) Int. Cl. F21V 8/00; F21V 7/04

(52) U.S. Cl. CPC G02B 6/0033; F21V 7/041
USPC 362/613; 362/346

(57) ABSTRACT

A reflector, a light source module, and a display device are disclosed. The reflector includes a substrate and slant reflecting surfaces disposed on the substrate and arranged from a first side to an opposite second side of the reflector. Each slant reflecting surface has an arc-shaped orthogonal projection on the substrate and is not parallel to the substrate. The light source module includes a light guide plate, a light emitting device, and the reflector, and the display device further includes a display panel. The light guide plate has a first surface, at least one opposite second surface, and a light incident surface connecting therebetween. The reflector is disposed at one side of the second surface. The slant reflecting surfaces are parallel to the second surface but not parallel to the first surface. The reflector offers improved luminous efficiency, and the light source module and the display device offer improved brightness.

### CROSS-REFERENCE TO RELATED APPLICATION

This application claims the priority benefit of China application serial no. 201310056579.9, filed on Feb. 22, 2013. The entirety of the above-mentioned patent application is hereby incorporated by reference herein and made a part of this specification.

### BACKGROUND OF THE INVENTION

1. Field of the Invention

The invention relates to an optical component and an optical module, and more particularly, to a reflector, a light source module, and a display device.

2. Description of Related Art

Along with the widespread of electronic products in recent years, display devices play a very important role in electronic products, and have become a focus of design. Among all display devices, liquid crystal display (LCD) has become the mainstream display device. A LCD is usually composed of a LCD panel and a backlight module. Because the LCD panel itself does not emit light beam, the backlight module is disposed below the LCD panel as a light source to allow the LCD panel to display images.

Backlight modules are categorized into direct-lit backlight modules and edge-lit backlight modules. In an edge-lit backlight module, the light source is disposed beside one side of a light guide plate, so that light beam enters the light guide plate from the one side and exits the light guide plate from the front. Thus, a single-sided light emission effect is achieved. A reflector is usually disposed at the back of the light guide plate. The reflector reflects light beam emitted from the back of the light guide plate back into the light guide plate, so that the light beam is emitted from the front of the light guide plate and accordingly the light extraction efficiency is improved. To increase the light extraction efficiency and the luminous uniformity and to control the direction of the exiting light, conventionally, some optical films, such as a diffuser and a prism sheet, have to be disposed on the front of the light guide plate. In addition, besides being applied to a LCD, a backlight module may also be adopted as a light source module for general illumination purpose or for illuminating any other optical device.

Referring to FIG. 11, a technique of disposing a slant reflecting plate 105 on a back surface 103b of a light guide device 103 is disclosed in U.S. Pat. No. 8,192,067. A reflecting surface 105a of the slant reflecting plate 105 has alternatively disposed first reflecting surfaces 105b and second reflecting surfaces 105c. The first reflecting surfaces 105b and the second reflecting surfaces 105c are respectively slanted with respect to a light transmission direction P. Accordingly, the reflecting surface 105a presents a zigzag shape. A reflecting film is disposed on the reflecting surface 105a. A prism sheet 104 is disposed on a front surface 103a of the light guide device 103 so that the light beam L1 is emitted in a direction perpendicular to that of the surface normal. Referring to FIG. 12, a technique of disposing a reflecting plate 23 on a bottom surface 222 of a light guide plate 22 is disclosed in China Patent No. 100405155C. The reflecting plate 23 includes a substrate 232 and a reflecting layer 233. The reflecting layer 233 has a grating structure 231. When light beam reaches the reflecting plate 23 from the bottom surface 222, the light beam is diffracted by the grating structure 231 to return to the light guide plate 22 and is then emitted out of the light guide plate 22 through the light emerging surface 223. A prism plate 24 is disposed at one side of the light emerging surface 223 of the light guide plate 22, and a diffuser plate 25 is disposed above the prism plate 24. Light beam is transmitted to a LCD panel (not shown) through the prism plate 24 and the diffuser plate 25.

### SUMMARY OF THE INVENTION

Accordingly, the invention is directed to a reflector capable of improving luminous efficiency.

The invention is directed to a light source module offering improved brightness.

The invention is directed to a display device offering improved brightness.

The other purposes and advantages of the invention may be further understood from the technical features of the disclosures of the invention.

For achieving the foregoing at least one of the purposes or the other purposes, an embodiment of the invention provides a reflector including a substrate and a plurality of slant reflecting surfaces. The substrate has a first side and a second side. The first side is opposite to the second side. The slant reflecting surfaces are disposed on the substrate and are arranged from the first side to the second side along an arrangement direction parallel to the substrate. An orthogonal projection of each of the slant reflecting surfaces on the substrate has an arc shape, and each of the slant reflecting surfaces is not parallel to the substrate.

According to an embodiment of the invention, the arc shape of each of the slant reflecting surfaces has an internal part faced the second side.

According to an embodiment of the invention, the arc shape of the slant reflecting surface respectively has a curvature, and the curvatures of the slant reflecting surfaces from the first side to the second side along the arrangement direction progressively increase.

According to an embodiment of the invention, the reflector further includes a plurality of junction surfaces, and each of the junction surfaces connects adjacent two of the slant reflecting surfaces.

According to an embodiment of the invention, the reflector includes a plurality of reflecting unit groups, and each of the reflecting unit groups includes at least one reflecting unit. Each of the reflecting units has one of the slant reflecting surfaces and one of the junction surfaces adjacent to each other, and there is a space between adjacent two of the reflecting unit groups.

According to an embodiment of the invention, the slant reflecting surfaces, the junction surfaces connecting the slant reflecting surfaces, and a part of the substrate form a bar-shaped arc prism, and a reflecting film is disposed on the slant reflecting surfaces.

According to an embodiment of the invention, the reflector further includes a plurality of junction surfaces and a plurality of top surfaces, the slant reflecting surfaces, the top surfaces, and the junction surfaces are alternatively arranged along the arrangement direction, and each of the top surfaces connects one of the slant reflecting surfaces and one of the junction surfaces.

According to an embodiment of the invention, the first side is a straight side, and the second side is a curve side.

An embodiment of the invention provides a light source module including a light guide plate, at least one light emitting device, and a reflector. The light guide plate has a first surface, at least one second surface opposite to the first surface, a light incident surface connecting the first surface and the at least one second surface, and a reflecting surface which is opposite to the light incident surface and connects the first surface. The light emitting device is disposed beside the light incident surface and emits at least one light beam. The at least one light beam enters the light guide plate through the light incident surface. The reflector is disposed at one side of the at least one second surface. The reflector includes a substrate and a plurality of slant reflecting surfaces disposed on the substrate. The slant reflecting surfaces are parallel to the at least one second surface, and the slant reflecting surfaces are not parallel to the first surface.

In the light source module provided by an embodiment of the invention, orthogonal projections of the slant reflecting surfaces on the substrate respectively have an arc shape.

In the light source module provided by an embodiment of the invention, the arc shape of each of the slant reflecting surfaces has an internal part faced the reflecting surface.

In the light source module provided by an embodiment of the invention, the arc shape of each of the slant reflecting surfaces respectively has a curvature, and the curvatures of the slant reflecting surfaces from one side of the light incident surface to one side of the reflecting surface progressively increase.

In the light source module provided by an embodiment of the invention, the slant reflecting surfaces face the reflecting surface slantwise.

In the light source module provided by an embodiment of the invention, the reflector further includes a plurality of junction surfaces, and each of the junction surfaces connects adjacent two of the slant reflecting surfaces.

In the light source module provided by an embodiment of the invention, the number of the at least one second surface is plural. The reflector includes a plurality of reflecting unit groups, and each of the reflecting unit groups includes at least one reflecting unit. Each of the reflecting units has one of the slant reflecting surfaces and one of the junction surfaces adjacent to each other, there is a space between adjacent two of the reflecting unit groups, and the at least one light beam is respectively reflected by the reflecting unit groups after the light beam passing through the second surfaces.

In the light source module provided by an embodiment of the invention, the slant reflecting surfaces, the junction surfaces connecting the slant reflecting surfaces, and a part of the substrate form a bar-shaped prism, and a reflecting film is disposed on the slant reflecting surfaces.

In the light source module provided by an embodiment of the invention, the reflector further includes a plurality of junction surfaces and a plurality of top surfaces, the slant reflecting surfaces, the top surfaces, and the junction surfaces are alternatively arranged along the direction from the light incident surface to the reflecting surface, and each of the top surfaces connects one of the slant reflecting surfaces and one of the junction surfaces.

In the light source module provided by an embodiment of the invention, the light source module further includes a reflecting portion disposed on the reflecting surface, at least a part of the at least one light beam from the light incident surface is reflected by the reflecting portion, passes through the at least one second surface, and is reflected by the slant reflecting surfaces sequentially.

In the light source module provided by an embodiment of the invention, an orthogonal projection of the reflecting surface on the first surface has an arc shape.

In the light source module provided by an embodiment of the invention, a thickness of the light guide plate in a direction perpendicular to the first surface progressively increases from a side close to the light incident surface to one side close to the reflecting surface.

In the light source module provided by an embodiment of the invention, the reflector has a straight side close to the light incident surface and a curve side close to the reflecting surface.

An embodiment of the invention provides a display device including a light guide plate, at least one light emitting device, a reflector, and a display panel. The light guide plate has a first surface, at least one second surface opposite to the first surface, and a light incident surface connecting the first surface and the at least one second surface. The light emitting device is disposed beside the light incident surface and emits at least one light beam. The at least one light beam enters the light guide plate through the light incident surface. The reflector is disposed at one side of the at least one second surface. The reflector includes a plurality of slant reflecting surfaces. The slant reflecting surfaces are parallel to the at least one second surface, and the slant reflecting surfaces are not parallel to the first surface. The display panel is disposed at one side of the first surface.

In the display device provided by an embodiment of the invention, no prism sheet is disposed between the first surface and the display panel.

As described above, the embodiment or embodiments of the invention have at least one of the following advantages. A reflector provided by an embodiment of the invention has arc slant reflecting surfaces. Thus, the reflector offers a directional light reflection effect and a reflected light concentration effect, so that the luminous efficiency is improved. Additionally, in a light source module provided by an embodiment of the invention, the slant reflecting surfaces of a reflector are approximately parallel to a second surface of a light guide plate. Thus, the light beam emitted by a light emitting device may be directionally reflected (i.e., the slant reflecting surfaces may reflect the light beam in a direction close to the normal direction of a first surface of the light guide plate), so that the brightness of the light source module is improved. Moreover, in a display device provided by an embodiment of the invention, collimated light may be produced and the brightness of a light source module may be improved without disposing a prism sheet between a light guide plate and a liquid crystal display (LCD) panel.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a light source module according to an embodiment of the invention.

FIG. 2 is an enlarged partial view of a light source module in FIG. 1.

FIG. 3 is an enlarged partial view of a reflector in FIG. 1.

FIG. 4 is a top view of the reflector in FIG. 1.

FIG. 5 is a diagram of a reflector according to another embodiment of the invention.

FIG. 6 is a partial bottom view of the light source module in FIG. 1.

FIG. 7 is a partial bottom view of a light source module according to another embodiment of the invention.

FIG. 8 is a diagram of a light source module according to another embodiment of the invention.

FIG. 9 is a diagram of a reflector according to another embodiment of the invention.

FIG. 10 is a diagram of a display device according to an embodiment of the invention.

FIG. 11 is a diagram of a conventional backlight module.

FIG. 12 is a diagram of a conventional backlight module.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

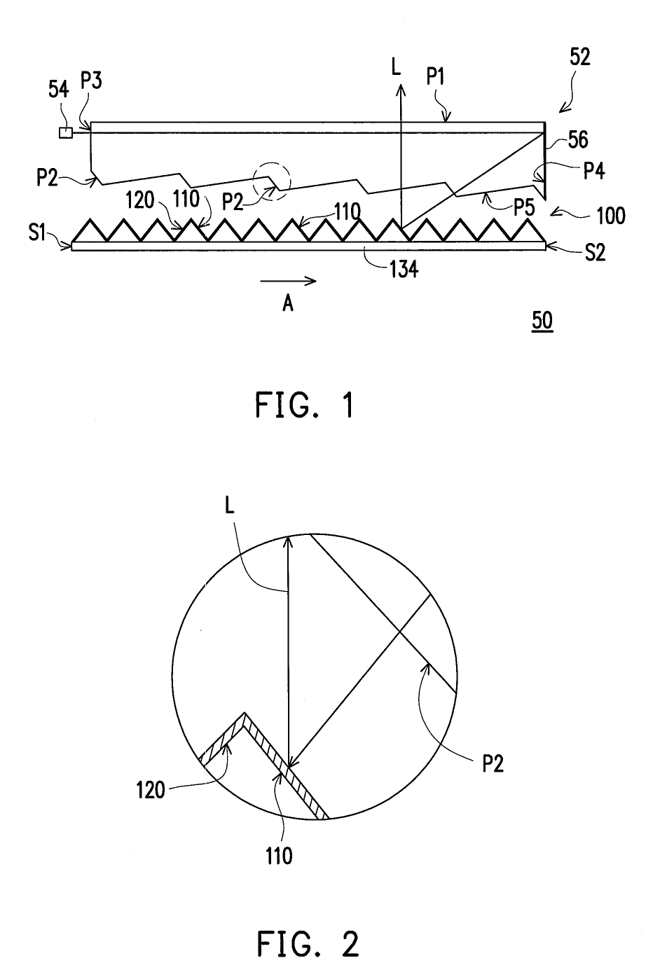

FIG. 1 is a diagram of a light source module according to an embodiment of the invention. Referring to FIG. 1, in the embodiment, the light source module 50 includes a light guide plate 52, at least one light emitting device 54, and a reflector 100. The light guide plate 52 has a first surface P1, at least one second surface P2 opposite to the first surface P1, a light incident surface P3 connecting the first surface P1 and the at least one second surface P2, and a reflecting surface P4 which is opposite to the light incident surface P3 and connects the first surface P1. The first surface P1 is not parallel to the at least one second surface P2. In the embodiment, the number of the aforementioned second surface P2 is plural. However, the number of the second surfaces P2 is not limited in the invention, and there may be one or more second surfaces P2.

In the embodiment, it is assumed that there is one light emitting device 54. The light emitting device 54 may be a light emitting diode (LED) disposed beside the light incident surface P3. The light emitting device 54 emits at least one light beam L, and the at least one light beam L enters the light guide plate 52 through the light incident surface P3. Besides, the light source module 50 further includes a reflecting portion 56 disposed on the reflecting surface P4. The reflector 100 is disposed at one side of the at least one second surfaces P2. Thus, after the light beam L enters the light guide plate 52 through the light incident surface P3, at least a part of the light beam L is reflected by the reflecting portion 56 disposed on the reflecting surface P4 and the reflector 100 disposed at one side of the second surfaces P2 and eventually emerges from the light guide plate 52 through the first surface P1 in a direction close to the normal of the first surface P1.

FIG. 2 is an enlarged partial view of a light source module in FIG. 1. FIG. 3 is an enlarged partial view of a reflector in FIG. 1. Referring to FIG. 1 to FIG. 3, in the embodiment, the reflector 100 includes a substrate 134 and a plurality of slant reflecting surfaces 110 disposed on the substrate 134. The slant reflecting surfaces 110 are arranged from a first side S1 of the substrate 134 to a second side S2 of the substrate 134. The first side S1 is opposite to the second side S2, and the first side S1 and the second side S2 are respectively corresponding to the light incident surface P3 and the reflecting surface P4 of the light guide plate 52. The slant reflecting surfaces 110 are not parallel to the substrate 134. An arrangement direction A of the slant reflecting surfaces 110 is from the first side S1 of the substrate 134 to the second side S2 thereof. In other words, the slant reflecting surfaces 110 are arranged from the first side S1 of the substrate 134 to the second side S2 of the substrate 134 along the arrangement direction A parallel to the substrate 134.

The slant reflecting surfaces 110 are approximately parallel to the second surfaces P2 but are not parallel to the first surface P1. Thus, after the light beam L enters the light guide plate 52 through the light incident surface P3, at least a part of the light beam L from the light incident surface P3 is reflected by the reflecting portion 56, passes through the second surfaces P2, and is reflected by the slant reflecting surfaces 110 in sequence and is eventually emitted out of the light guide plate 52 through the first surface P1. In the embodiment, the inclination angle θ of the slant reflecting surfaces 110 (i.e., the angle between the slant reflecting surfaces 110 and the normal N of the substrate 134 of the reflector 100) may be between 30° and 60°. However, the invention is not limited thereto, and the inclination angle θ of the slant reflecting surfaces 110 may be adjusted according to the actual requirement.

On the other hand, in the embodiment, the reflector 100 further includes a plurality of junction surfaces 120. Each of the junction surfaces 120 connects adjacent two of the slant reflecting surfaces 110. The slant reflecting surfaces 110 and the junction surfaces 120 are alternatively arranged from one side of the light incident surface P3 to one side of the reflecting surface P4. Namely, the slant reflecting surfaces 110 and the junction surfaces 120 are alternatively arranged from the first side S1 of the substrate 134 to the second side S2 thereof along the arrangement direction A. The junction surfaces 120 face the light incident surface P3 slantwise, and the slant reflecting surfaces 110 face the reflecting surface P4 slantwise, so that the light beam L is reflected by the reflecting surface P4 and passes through the second surfaces P2.

To be specific, referring to FIG. 1 to FIG. 3, in the embodiment, the slant reflecting surface 110, the junction surface 120 connecting the slant reflecting surface 110, and a part of the substrate 134 form a bar-shaped prism 132. A plurality of the bar-shaped prisms 132 are arranged on the substrate 134 from a side close to the light incident surface P3 to a side farther away from the light incident surface P3 (i.e., the reflecting surface P4). In other words, the bar-shaped prisms 132 are arranged from the first side S1 to the second side S2. The bar-shaped prisms 132 may be in the shape of straight bars, curve bars, wavy bars, or zigzag bars (not shown). However, the invention is not limited thereto. A reflecting film 140 is disposed on the surfaces of the bar-shaped prisms 132, where part of the reflecting film 140 is disposed on the slant reflecting surfaces 110, while another part of the reflecting film 140 is disposed on the junction surfaces 120. The reflecting film 140 may be formed by coating a reflecting material (for example, metal or metal oxide) on the surfaces of the bar-shaped prisms 132 through a sputtering process or an evaporation process, so as to form the slant reflecting surfaces 110 with a reflecting function. However, the material and formation method of the reflecting film 140 are not limited in the invention.

On the other hand, in the embodiment, to form the bar-shaped prisms 132, a light curable adhesive (for example, UV adhesive) or a heat curable adhesive is coated on the substrate 134, and then the light curable adhesive or heat curable adhesive is rolled over by using a roller with V-shaped embossment to form a plurality of V-shaped grooves, so that the bar-shaped prisms 132 are formed between every two V-shaped grooves. The bar-shaped prisms 132 are formed once the light curable adhesive or heat curable adhesive is cured. However, in the invention, the technique of forming the bar-shaped prisms 132 is not limited to that described above.

Additionally, to simplify the process, the cross section of each bar-shaped prism 132 is an isosceles triangle. The junction surfaces 120 are mirror-symmetrical to the slant reflecting surfaces 110 and have the same surface area as the slant reflecting surfaces 110. However, the invention is not limited thereto, and in other embodiments, the junction surfaces 120 may be planes parallel to the normal N of the substrate 134, or the surface area of each junction surface 120 may be greater than that of each slant reflecting surface 110.

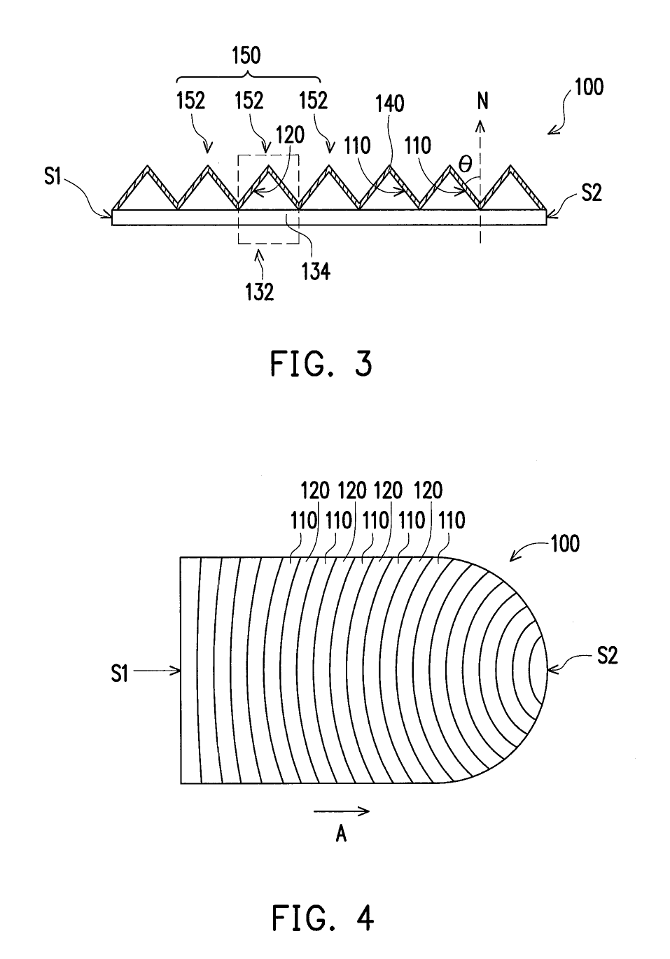

FIG. 4 is a top view of the reflector in FIG. 1. Referring to FIG. 3 and FIG. 4, in the embodiment, each of the slant reflecting surfaces 110 is in an arc shape (i.e., orthogonal projections of the slant reflecting surfaces 110 on the substrate 134 respectively have an arc shape). However, the invention is not limited thereto, and each slant reflecting surface 110 may also be in a straight bar shape, a wavy shape, or a zigzag shape. The arc-shaped slant reflecting surfaces 110 are arranged from the first side S1 to the second side S2 of the substrate 134. Meanwhile, the junction surfaces 120 are also in arc shape such that the slant reflecting surfaces 110 and the junction surfaces 120 are alternatively arranged from the first side S1 to the second side S2. Accordingly, in the embodiment, the reflecting film 140 is actually disposed on the arc-shaped bar-shaped prisms 132 (i.e., on the arc-shaped slant reflecting surfaces 110 and the junction surfaces 120).

To be specific, in the embodiment, each slant reflecting surface 110 is located between the curvature center of the arc-shaped section of the slant reflecting surface 110 and the first side S1 which is close to the light incident surface P3. In short, the arc shape of each of the slant reflecting surfaces 110 has its internal part faced the second side S2 (i.e., the arc shape of each of the slant reflecting surfaces 110 has its internal part faced the reflecting surface P4). Accordingly, the light beam L which is reflected by the reflecting surface P4 and passes through the second surfaces P2 to reach the slant reflecting surfaces 110 may be reflected, so that the divergence angle of the light beam L in the direction perpendicular to the arrangement direction A is converged, and eventually the light beam L is transmitted to the first surface P1 of the light guide plate 52 and is emitted.

In the embodiment, the reflector 100 has a straight side close to the light incident surface P3 and a curve side close to the reflecting surface P4. In other words, the first side S1 of the substrate 134 is a straight side, and the second side S2 thereof is a curve side. The second side S2 may be an arc having its internal part facing the first side S1. However, the shape of the curve of the second side S2 is not limited in the invention, and in other embodiments, the second side S2 of the substrate 134 may be a curve side or a straight side which allows the reflector 100 to have a rectangular appearance. In other words, the second side S2 of the substrate 134 may be a curve side or a straight side, which is not limited in the invention. In addition, the arc shape of the slant reflecting surface 110 respectively has a curvature, and the curvatures of the arc shapes of the slant reflecting surfaces 110 from the first side S1 to the second side S2 along the arrangement direction A progressively increase (i.e., from one side of the light incident surface P3 to one side of the reflecting surface P4, as shown in FIG. 4). However, the invention is not limited thereto, and in other embodiments, the curvature or shape of the slant reflecting surfaces 110 may be adjusted according to the actual requirement.

As described above, after the light beam L enters the light guide plate 52 through the light incident surface P3, the light beam L is reflected by the reflecting surface P4, passes through the second surfaces P2, and reaches the slant reflecting surfaces 110 in sequence, so that the light beam L is eventually emitted from the first surface P1 of the light guide plate 52 through the reflection of the slant reflecting surfaces 110. Besides, because the slant reflecting surfaces 110 of the reflector 100 are approximately parallel to the second surfaces P2, the light beam L emitted by the light emitting device 54 may be directionally reflected. In other words, the slant reflecting surfaces 110 may reflect the light beam L in a direction close to the normal of the first surface P1. Thus, in the embodiment, the brightness of the light source module 50 may be increased directly through the reflector 100 without disposing any prism sheet for guiding the transmission direction of the light beam L on the first surface P1 of the light guide plate 52. Moreover, if specular reflection is adopted by the slant reflecting surfaces 110, the light beam L may be prevented from diffusing and the directivity thereof may be improved.

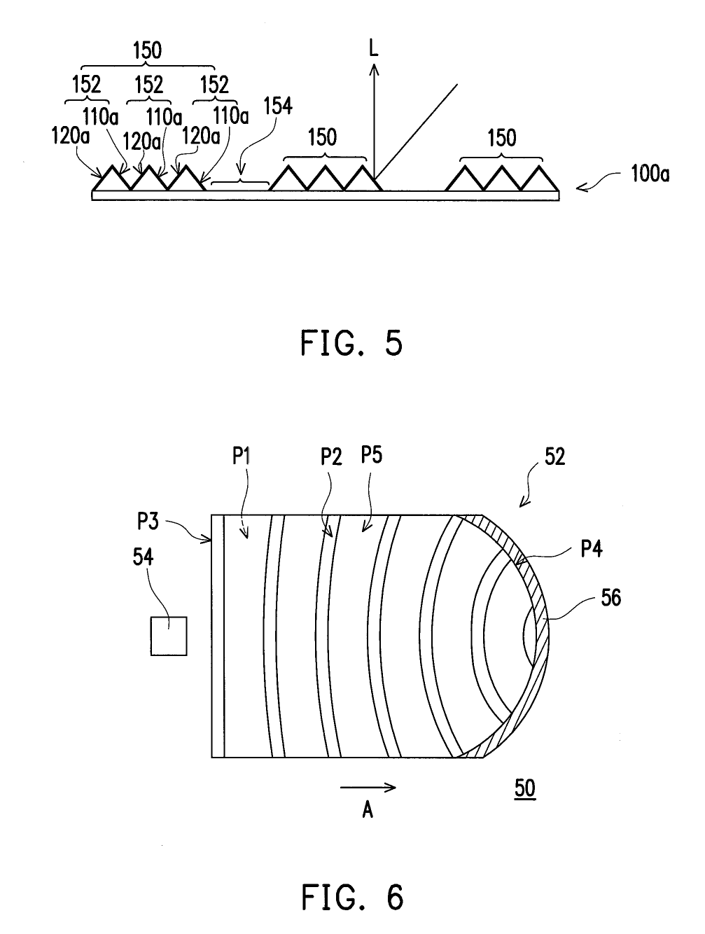

FIG. 5 is a diagram of a reflector according to another embodiment of the invention. Referring to FIG. 1 and FIG. 5, the reflector 100a in the embodiment may also be applied to the light source module 50 illustrated in FIG. 1, the light source module 50b illustrated in FIG. 8, or the display device 10 illustrated in FIG. 10. The main difference between the reflector 100a and the reflector 100 is that the reflector 100a includes a plurality of reflecting unit groups 150. Each of the reflecting unit groups 150 includes at least one reflecting unit 152 (for example, three reflecting units 152). Each of the reflecting units 152 has one of slant reflecting surfaces 110a and one of junction surfaces 120a adjacent to each other. The slant reflecting surfaces 110a and the junction surfaces 120a are alternatively arranged so that the reflecting units 152 present a continuous arranged. There is a space 154 between adjacent two of the reflecting unit groups 150, and the light beam L is respectively reflected by the reflecting unit groups 150 after it passes through the second surfaces P2. Namely, each second surface P2 is corresponding to one reflecting unit group 150. However, the number of reflecting units 152 in a single reflecting unit group 150 is not limited in the invention, and in other embodiments, each reflecting unit group 150 of the reflector may include only one reflecting unit 152.

Similarly, in the reflecting unit 152 of the reflecting unit group 150 of the reflector 100a, the slant reflecting surface 110a and the junction surface 120a may be implemented through the same technique of forming the bar-shaped prisms 132 and the reflecting film 140 described above. However, the invention is not limited thereto. Thereby, the reflector 100 in FIG. 1 may be considered as including only one reflecting unit group 150, the reflecting unit group 150 may include a plurality of reflecting units 152 that are continuously arranged, the slant reflecting surfaces 110 and the junction surfaces 120 in these reflecting units 152 are alternatively arranged, and the light beam L is reflected by the reflecting unit group 150 after it passes through the second surfaces P2, as shown in FIG. 1.

FIG. 6 is a partial bottom view of the light source module in FIG. 1. Some components (for example, the reflector 100) of the light source module 50 are omitted in FIG. 6 in order to make the drawing easier to understand. Referring to both FIG. 1 and FIG. 6, in the embodiment, the light guide plate 52 further includes junction surfaces P5. The junction surfaces P5 and the second surfaces P2 are alternatively arranged. Besides, the junction surfaces P5 may not be parallel to the second surfaces P2, so that the light guide plate 52 presents a zigzag shape. The reflecting surface P4 in FIG. 6 connects some of the junction surfaces P5 and some of the second surfaces P2. However, the invention is not limited thereto, and the reflecting surface P4 may also connect only one junction surface P5 or only one second surface P2. Referring to FIG. 1, the junction surfaces P5 face the light incident surface P3. However, the invention is not limited thereto, and in other embodiments, the inclination direction of the junction surfaces P5 may also be parallel to the second surfaces P2 or the first surface P1. Additionally, a thickness of the light guide plate 52 in the direction perpendicular to the first surface P1 progressively increases from the side close to the light incident surface P3 to one side of the reflecting surface P4.

On the other hand, in the embodiment, the reflecting portion 56 disposed on the reflecting surface P4 may be a reflective coating applied on the reflecting surface P4 or a reflecting sheet or reflecting film attached on the reflecting surface P4. However, the material and formation method of the reflecting portion 56 are not limited in the invention. In addition, the light incident surface P3 of the light guide plate 52 is a straight surface (i.e., an orthogonal projection of the light incident surface P3 on the first surface P1 is a straight line). Contrarily, the reflecting surface P4 of the light guide plate 52 is an arc surface (i.e., an orthogonal projection of the reflecting surface P4 on the first surface P1 is an arc., where the internal part of the arc-shaped reflecting surface P4 faces the light incident surface P3), and the arc-shaped second side S2 of the reflector 100 may be designed in accordance with the arc-shaped reflecting surface P4).

To be specific, in the embodiment, the orthogonal projection of the reflecting surface P4 on the first surface P1 may be parabolic-shaped. However, the invention is not limited thereto. Thus, when the light emitting device 54 disposed at one side of the light incident surface P3 is a point light source, the light emitting device 54 may be disposed at the focal point of the parabolic-shaped reflecting surface P4. The light beam L emitted by the light emitting device 54 is reflected by the reflecting portion 56 disposed on the reflecting surface P4, so that the light beam L is concentrated in the direction parallel to the light incident surface P3 (i.e., perpendicular to the arrangement direction A) and accordingly emitted from the first surface P1 approximately in the normal direction of the first surface P1. Thereby, the forward luminance of the light source module 100 is effectively increased.

Additionally, in the embodiment, the second surfaces P2 of the light guide plate 52 is also be in an arc shape and is corresponding to the arc-shaped slant reflecting surfaces 110 of the reflector 100 (as shown in FIG. 4). The arc-shaped second surfaces P2 are arranged from the light incident surface P3 to the reflecting surface P4 of the light guide plate 52, and the internal parts of the arc-shaped second surfaces P2 face the reflecting surface P4. Thus, after the light beam L is reflected by the reflecting surface P4, the light beam L passes through the arc-shaped second surfaces P2 and reaches the slant reflecting surfaces 110. Then, the light beam L is reflected by the arc-shaped slant reflecting surfaces 110 and is eventually emitted out of the light guide plate 52 through the first surface P1.

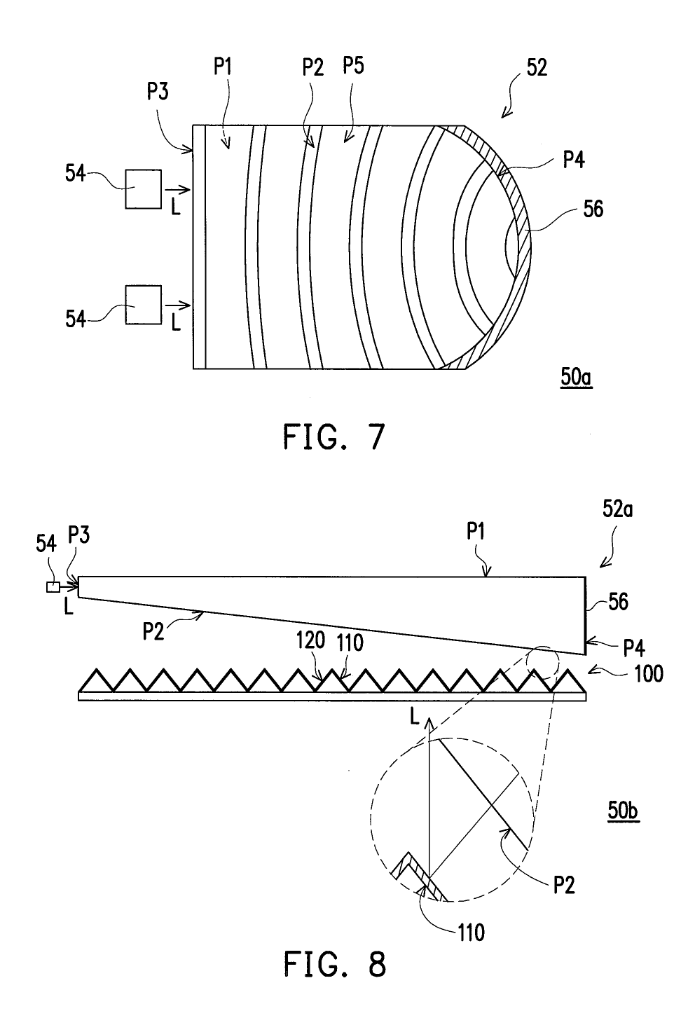

FIG. 7 is a partial bottom view of a light source module according to another embodiment of the invention. Some components (for example, the reflector 100) of the light source module 50a are omitted in FIG. 7 in order to make the drawing easier to understand. Referring to both FIG. 1 and FIG. 7, in the embodiment, the light source module 50a includes two light emitting devices 54 (for example, two light emitting diodes (LEDs)) symmetrically disposed beside the light incident surface P3. The distance between the two light emitting devices 54 may be adjusted according to the actual requirement. The two light emitting devices 54 respectively emit a light beam L, and the two light beams L enter the light guide plate 52 through the light incident surface P3. However, the two light emitting devices 54 are not limited to being symmetrically disposed beside the light incident surface P3 in the invention, and in other embodiments, the positions of the two light emitting devices 54 may be adjusted according to the actual requirement. However, the number, type, and positions of the light emitting devices 54 are not limited in the invention, and in other embodiments, the light source module 50a may include more light emitting devices 54 and these light emitting devices 54 may be disposed according to the actual requirement.

FIG. 8 is a diagram of a light source module according to another embodiment of the invention. Referring to FIG. 1 and FIG. 8, in the embodiment, the light guide plate 52a may also be applied to the light source module 50 illustrated in FIG. 1 or the display device 10 illustrated in FIG. 10. In the light source module 50b illustrated in FIG. 8, the light guide plate 52a includes a second surface P2. The light incident surface P3 and the reflecting surface P4 connect the second surface P2, and the thickness of the light guide plate 52a in the direction perpendicular to the first surface P1 progressively increases from the side close to the light incident surface P3 to the side close to the reflecting surface P4, so that the light guide plate 52a presents a wedge shape. Similarly, the reflector 100 is disposed at one side of the second surface P2 of the light guide plate 52a. The slant reflecting surfaces 110 of the reflector 100 are approximately parallel to the second surface P2 (referring to the enlarged view in FIG. 8) but are not parallel to the first surface P1. Thus, the light beam L enters the light guide plate 52a through the light incident surface P3 and is reflected by the reflecting portion 56 disposed on the reflecting surface P4, passes through the second surface P2, and is reflected by the slant reflecting surfaces 110 in sequence. Eventually, the light beam L is emitted from the first surface P1, as shown in FIG. 1 and the enlarged partial view in FIG. 8. Thus, the light extraction efficiency of the light source modules 50 and 50b is improved.

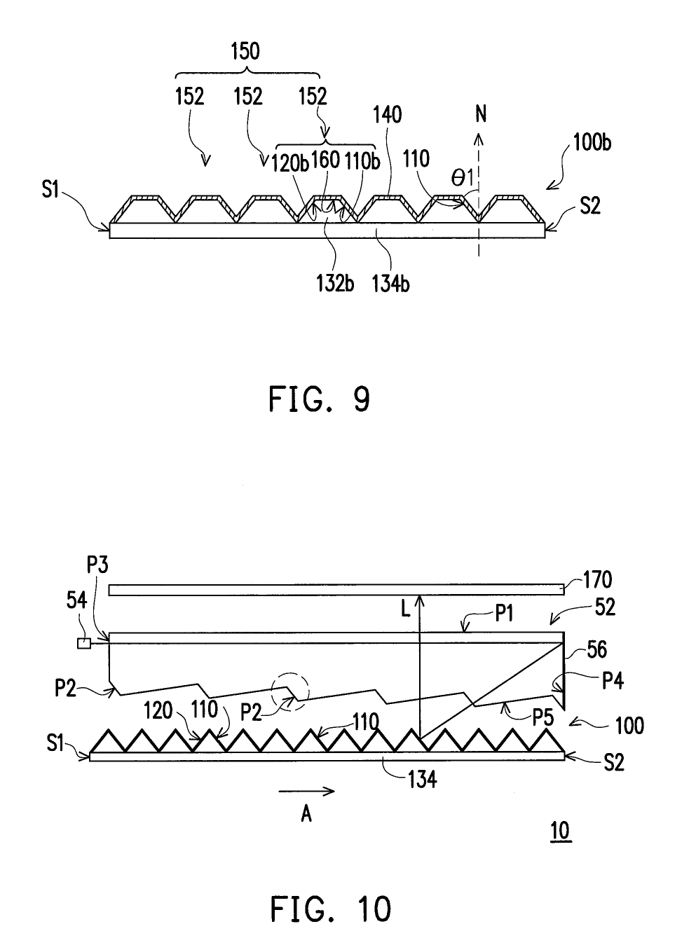

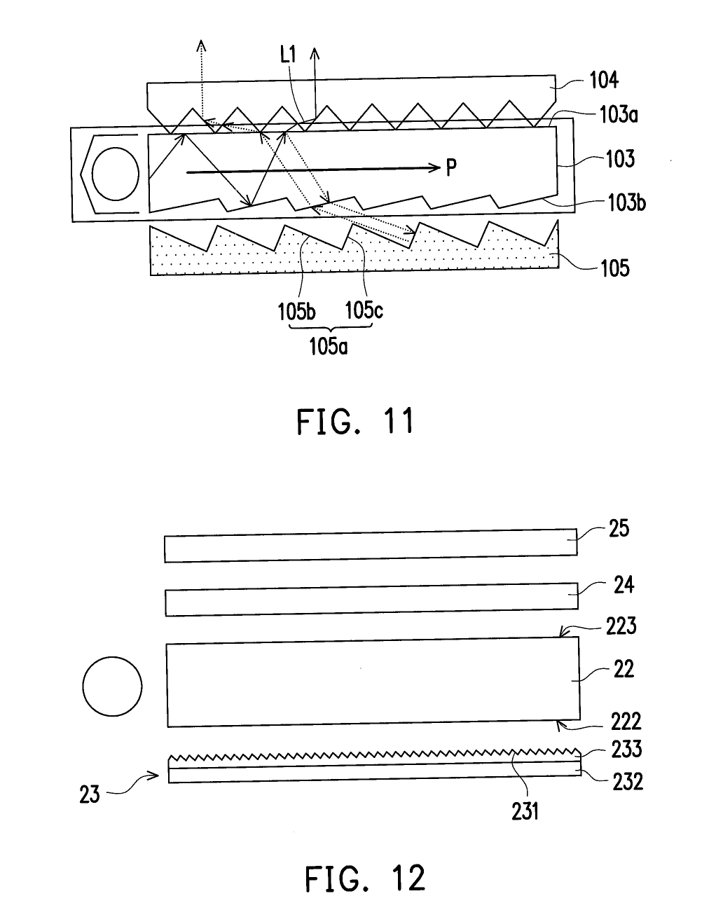

FIG. 9 is a diagram of a reflector according to another embodiment of the invention. Referring to FIG. 1, FIG. 4, and FIG. 9, in the embodiment, the reflector 100b may be applied to the light source module 50 illustrated in FIG. 1, the light source module 50b illustrated in FIG. 8, or the display device 10 illustrated in FIG. 10. The main difference between the reflector 100b and the reflector 100 is that the cross section of each bar-shaped prism 132b in the reflector 100b presents a trapezoid shape. To be specific, the reflector 100b in FIG. 9 further includes a plurality of top surfaces 160, each of the top surfaces 160 connects one of the slant reflecting surfaces 110b and one of the junction surfaces 120b. The same effect as described above may be accomplished with the inclination angle θ1 of the slant reflecting surfaces 110b (i.e., the angle formed by each slant reflecting surface 110b and the normal N of the substrate 134b) between 30° and 60° and will not be described herein.

FIG. 10 is a diagram of a display device according to an embodiment of the invention. Any reflector or light source module mentioned above may be applied to the embodiment. As shown in FIG. 10, a display panel 170 is disposed at one side of the first surface P1 of the light guide plate 52. As described above, after the light beam L enters the light guide plate 52 through the light incident surface P3, the light beam L is reflected by the reflecting surface P4, passes through the second surface P2, and reaches the slant reflecting surfaces 110 in sequence. After being reflected by the slant reflecting surfaces 110, the light beam L passes through the first surface P1 of the light guide plate 52 and reaches the display panel 170. In addition, because the slant reflecting surfaces 110 of the reflector 100 are approximately parallel to the second surface P2, the light beam L emitted by the light emitting device 54 may be directionally reflected. In other words, the slant reflecting surfaces 110 reflects the light beam L in a direction close to the normal direction of the first surface P1, so that the light beam L may be straightly emitted to the display panel 170. Thus, without any prism sheet disposed on the first surface P1 of the light guide plate 52 for guiding the transmission direction of the light beam L (i.e., no prism sheet is disposed between the first surface P1 and the display panel 170), the brightness of the display device 10 may be improved directly through the reflector 100. Moreover, to increase the luminous uniformity of the display device 10, a diffuser (not shown) may be disposed on the first surface P1 of the light guide plate 52 (i.e., between the first surface P1 and the display panel 170) for uniformizing the light beam L emitted through the first surface P1.

As described above, a reflector, a light source module, and a display device provided by embodiments of the invention have at least following advantages. The reflector provided by an embodiment of the invention has arc-shaped slant reflecting surfaces. These arc-shaped slant reflecting surfaces may reflect light beam directionally and concentrate the reflected light beam, so that the light extraction efficiency of the reflector is improved. In addition, in the light source module provided by an embodiment of the invention, the reflector is disposed at one side of at least one second surface of a light guide plate of the light source module. Because the slant reflecting surfaces have an arc shape and are not faced towards the light incident surface of the light guide plate and the slant reflecting surfaces of the reflector are parallel to the second surface of the light guide plate, the light beam emitted by the light emitting device may be directionally reflected to the first surface (i.e., the slant reflecting surfaces may reflect the light beam in a direction closer to the normal direction of the first surface of the light guide plate), so that the brightness of the light source module may be increased. In the display device provided by an embodiment of the invention, straight light beam may be achieved and accordingly the brightness of the light source module may be improved without disposing any prism sheet between the light guide plate and a liquid crystal display (LCD) panel (as in the conventional technique). Thereby, the reflector provided by an embodiment of the invention offers improved light extraction efficiency, and the brightness of a light source module and the display device may be increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A reflector, comprising:
a substrate, having a first side and a second side, wherein the first side is opposite to the second side; and
a plurality of slant reflecting surfaces, disposed on the substrate and arranged from the first side to the second side along an arrangement direction parallel to the substrate, wherein an orthogonal projection of each of the slant reflecting surfaces on the substrate has an arc shape, and each of the slant reflecting surfaces is not parallel to the substrate.

2. The reflector according to claim 1, wherein the arc shape of each of the slant reflecting surfaces has an internal part faced the second side.

3. The reflector according to claim 2, wherein the arc shape of the slant reflecting surface respectively has a curvature, and the curvatures of the slant reflecting surfaces from the first side to the second side along the arrangement direction progressively increase.

4. The reflector according to claim 1 further comprising a plurality of junction surfaces, wherein each of the junction surfaces connects adjacent two of the slant reflecting surfaces.

5. The reflector according to claim 4 comprising a plurality of reflecting unit groups, wherein each of the reflecting unit groups comprises at least one reflecting unit, each of the reflecting units has one of the slant reflecting surfaces and one of the junction surfaces adjacent to each other, and there is a space between adjacent two of the reflecting unit groups.

6. The reflector according to claim 4, wherein the slant reflecting surfaces, the junction surfaces connecting the slant reflecting surfaces, and a part of the substrate form a bar-shaped arc prism, and a reflecting film is disposed on the slant reflecting surfaces.

7. The reflector according to claim 1 further comprising a plurality of junction surfaces and a plurality of top surfaces, wherein the slant reflecting surfaces, the top surfaces, and the junction surfaces are alternatively arranged along the arrangement direction, and each of the top surfaces connects one of the slant reflecting surfaces and one of the junction surfaces.

8. The reflector according to claim 1, wherein the first side is a straight side, and the second side is a curve side.

9. A light source module, comprising:
a light guide plate, having a first surface, at least one second surface opposite to the first surface, a light incident surface connecting the first surface and the at least one second surface, and a reflecting surface opposite to the light incident surface, wherein the reflecting surface connects the first surface,
at least one light emitting device, disposed beside the light incident surface, and emitting at least one light beam, wherein the at least one light beam enters the light guide plate through the light incident surface; and
a reflector, disposed at one side of the at least one second surface, and comprising a substrate and a plurality of slant reflecting surfaces disposed on the substrate, wherein the slant reflecting surfaces are parallel to the at least one second surface, and the slant reflecting surfaces are not parallel to the first surface.

10. The light source module according to claim 9, wherein orthogonal projections of the slant reflecting surfaces on the substrate respectively have an arc shape.

11. The light source module according to claim 10, wherein the arc shape of each of the slant reflecting surfaces has an internal part faced the reflecting surface.

12. The light source module according to claim 10, wherein the arc shape of each of the slant reflecting surfaces respectively has a curvature, and the curvatures of the slant reflecting surfaces from one side of the light incident surface to one side of the reflecting surface progressively increase.

13. The light source module according to claim 9, wherein the slant reflecting surfaces face the reflecting surface slantwise.

14. The light source module according to claim 9, wherein the reflector further comprises a plurality of junction surfaces, and each of the junction surfaces connects adjacent two of the slant reflecting surfaces.

15. The light source module according to claim 14, wherein the number of the at least one second surface is plural, the reflector comprises a plurality of reflecting unit groups, each of the reflecting unit groups comprises at least one reflecting unit, each of the reflecting units has one of the slant reflecting surfaces and one of the junction surfaces adjacent to each other, there is a space between adjacent two of the reflecting unit groups, and the at least one light beam is respectively reflected by the reflecting unit groups after the light beam passes through the second surfaces.

16. The light source module according to claim 14, wherein the slant reflecting surfaces, the junction surfaces connecting the slant reflecting surfaces, and a part of the substrate form a bar-shaped prism, and a reflecting film is disposed on the slant reflecting surfaces.

17. The light source module according to claim 9, wherein the reflector further comprises a plurality of junction surfaces and a plurality of top surfaces, the slant reflecting surfaces, the top surfaces, and the junction surfaces are alternatively arranged along the direction from the light incident surface to the reflecting surface, and each of the top surfaces connects one of the slant reflecting surfaces and one of the junction surfaces.

18. The light source module according to claim 9, wherein the light source module further comprises a reflecting portion disposed on the reflecting surface, at least a part of the at least one light beam from the light incident surface is reflected by the reflecting portion, passes through the at least one second surface, and is reflected by the slant reflecting surfaces sequentially.

19. The light source module according to claim 9, wherein an orthogonal projection of the reflecting surface on the first surface has an arc shape.

20. The light source module according to claim 9, wherein a thickness of the light guide plate in a direction perpendicular to the first surface progressively increases from a side close to the light incident surface to one side close to the reflecting surface.

21. The light source module according to claim 9, wherein the reflector has a straight side close to the light incident surface and a curve side close to the reflecting surface.

22. A display device, comprising:
a light guide plate, having a first surface, at least one second surface opposite to the first surface, and a light incident surface connecting the first surface and the at least one second surface;
at least one light emitting device, disposed beside the light incident surface, and emitting at least one light beam, wherein the at least one light beam enters the light guide plate through the light incident surface;
a reflector, disposed at one side of the at least one second surface, and comprising a plurality of slant reflecting surfaces, wherein the slant reflecting surfaces are parallel to the at least one second surface, and the slant reflecting surfaces are not parallel to the first surface; and
a display panel, disposed at one side of the first surface.

23. The display device according to claim 22, wherein no prism sheet is disposed between the first surface and the display panel.
